(19) United States
(12) Patent Application Publication
(10) Pub. No.: US 2021/0321630 A1
(43) Pub. Date: Oct. 21, 2021

(54) PLASTIC OIL AND FAT COMPOSITION FOR BAKERY FOOD DOUGH

(71) Applicant: J-OIL MILLS, INC., Tokyo (JP)

(72) Inventors: Ryosuke AOKI, Tokyo (JP); Chihiro ISHIKAWA, Tokyo (JP); Satoshi SHIMURA, Tokyo (JP)

(21) Appl. No.: 17/271,676

(22) PCT Filed: Aug. 29, 2019
(86) PCT No.: PCT/JP2019/033821

§ 371 Date: Feb. 26, 2021

(30) Foreign Application Priority Data
Sep. 11, 2018 (JP) 2018-169259
Oct. 17, 2018 (JP) 2018-195865

(51) Int. Cl. A21D 2/16; A21D 13/16; A23D 9/04; A23D 7/04

(52) U.S. Cl. CPC A21D 2/16; A23D 7/04; A23D 9/04; A21D 13/16

(57) ABSTRACT

The present invention relates to a plastic oil and fat composition for bakery food dough, wherein the plastic oil and fat composition has excellent extensibility, a method for producing the same, bakery food dough, bakery food, or the like. The present invention also relates to a method for improving extensibility of a plastic oil and fat composition containing edible oil and fat, and a method for improving rising of a layered puffed food. The plastic oil and fat composition for bakery food dough of the present invention is characterized in that it contains 60% by mass to 100% by mass of an edible oil and fat, in which the edible oil and fat contains 0.5% by mass to 20% by mass of soybean hypocotyl oil.

### TECHNICAL FIELD

The present invention relates to a plastic oil and fat composition for bakery food dough.

### BACKGROUND ART

Soybeans are used as an oil raw material. Soybean is composed of about 90% by mass of seed leaf, about 8% by mass of seed coat, and about 2% by mass of hypocotyl (also called germ). Generally, soybean oil is obtained by squeezing soybeans from which the seed coat has been removed.

Soybean hypocotyl oil is obtained by squeezing oil from a raw material in which the proportion of soybean hypocotyl is increased from 15% by mass to 100% by mass. It is disclosed that soybean hypocotyl oil has health effects of, for example, reducing cholesterol in the body (Patent Literature 1) and suppressing metabolic syndrome (Patent Literature 2). Meanwhile, none of Patent Literature 1 and 2 discloses or suggests that in a case in which a plastic oil and fat composition containing a specific amount of soybean hypocotyl oil is used for preparing bakery food dough, the plastic oil and fat composition has excellent extensibility.

### CITATION LIST

### Patent Literature

Patent Literature 1: WO2001/032032
Patent Literature 2: WO2018/012262

### SUMMARY OF INVENTION

### Technical Problem

An object of the present invention is to provide a plastic oil and fat composition for bakery food dough, wherein the plastic oil and fat composition has excellent extensibility.

### Solution to Problem

The present inventors found that a plastic oil and fat composition containing a specific amount of an edible oil and fat containing a specific amount of soybean hypocotyl oil has excellent extensibility and thus is preferable for bakery food dough. This has led to the completion of the present invention.

Specifically, the present invention relates to a plastic oil and fat composition for dough for a bakery food, comprising 60% by mass to 100% by mass of an edible oil and fat, wherein the edible oil and fat contains 0.5% by mass to 20% by mass of soybean hypocotyl oil.

It is preferable that the edible oil and fat has a solid fat content of 20% to 70% at 10° C. and a solid fat content of 0% to 15% at 35° C.

It is preferable that the edible oil and fat contains 0% by mass to 60% by mass of a liquid oil and fat (other than soybean hypocotyl oil) having a solid fat content of 0% to 5% at 10° C.

It is preferable that the ratio of the content of the liquid oil and fat to the content of the soybean hypocotyl oil (liquid oil and fat/soybean hypocotyl oil) in the edible oil and fat is 0 to 100 on a mass basis.

It is preferable that the bakery food is a layered puffed food.

The present invention also relates to dough for a bakery food, comprising the plastic oil and fat composition.

It is preferable that the plastic oil and fat composition is mixed thereinto in such a way to form layers.

The present invention also relates to a bakery food, which is obtained by heating the dough.

The present invention also relates to a method for producing a plastic oil and fat composition for dough for a bakery food, comprising:

a step of preparing an oil and fat composition containing 60% by mass to 100% by mass of an edible oil and fat having a soybean hypocotyl oil content of 0.5% by mass to 20% by mass; and

a step of quenching kneading the oil and fat composition.

The present invention also relates to a method for improving extensibility of a plastic oil and fat composition containing an edible oil and fat, comprising allowing the edible oil and fat to contain a soybean hypocotyl oil.

The present invention also relates to a method for improving rising of a layered puffed food, wherein the layered puffed food is obtained by heating dough for a bakery food in which a plastic oil and fat composition containing an edible oil and fat is mixed into flour dough in such a way to form layers, the method comprising allowing the edible oil and fat to contain soybean hypocotyl oil.

### Advantageous Effects of Invention

As the plastic oil and fat composition of the present invention has excellent extensibility, it can be preferably used for dough for a bakery food. Here, the expression “excellent extensibility” means that a plastic oil and fat composition can be extended to be same extent as flour dough during the production of dough for a bakery food which requires adding flour dough with a plastic oil and fat composition and then mixing the plastic oil and fat composition into the flour dough in such a way to form layers. According to preferred embodiments of the present invention, particularly in a case in which the bakery food is a layered puffed food, it is possible not only to improve workability during preparing the dough but also to improve rising and crispy texture of the layered puffed food. Here, the term “flour dough” refers to dough in which raw materials including flour are uniformly mixed.

### DESCRIPTION OF EMBODIMENTS

The plastic oil and fat composition of the present invention contains 60% by mass to 100% by mass of an edible oil and fat, in which the edible oil and fat contains 0.5% by mass to 20% by mass of soybean hypocotyl oil.

The soybean hypocotyl oil is an oil and fat extracted and refined from a raw material in which the proportion of hypocotyl in soybean seeds is increased. The raw material in which the proportion of hypocotyl in soybean seeds is increased is a raw material containing 15% by mass to 100% by mass of hypocotyl, and it is preferable to use a raw material containing 30% by mass to 100% by mass of hypocotyl.

A method for selecting hypocotyl from soybean seeds and extracting and refining soybean hypocotyl oil from the hypocotyl is based on a conventional method. An example thereof is outlined below. First, soybean seeds are heated and dried at, for example, 40° C. to 80° C. Subsequently, seed leaf, seed coat, and hypocotyl are separated by peeling, crushing, roughly pulverizing, or pulverizing a dried product using a general-purpose pulverizer having at least one of impact action, shearing action, compression/pressing action, and frictional action. The impact means used herein is an impact mill, a jaw crusher, a stamp mill, a jet mill, a hammer mill, a pin mill, a rotary mill, a planetary mill, or the like, the searing means used herein is a cutter mill, a stone mill, or the like, the compression/pressing means used herein is a roller mill, a roll crusher, a pressing roll, a ring mill, or the like, and the friction means used herein is a stream mill or the like.

Next, the mixture of separated seed coat, seed leaf, and hypocotyl is passed through a vibration sieve, a rotary sieve, an air classifier, or the like to remove the seed coat and seed leaf from the mixture to obtain a hypocotyl fraction. For example, a fraction which passed through a 7-mesh sieve is further fractionated to obtain a fraction between a 10-mesh sieve and a 14-mesh sieve.

The hypocotyl fraction is heated at a temperature of 40° C. to 100° C. for several seconds to 60 minutes, then pressed to form flakes, and the flakes are brought into contact with an organic solvent such as n-hexane, thereby obtaining crude oil. In addition, soybean hypocotyl oil is obtained by treating crude oil in any one or more of degumming, deoxidizing, decoloring, and deodorizing steps, preferably degumming, deoxidizing, decoloring, and deodorizing steps, according to a conventional method. The soybean hypocotyl oil may be a commercially available product.

The plastic oil and fat composition of the present invention contains 60% by mass to 100% by mass of an edible oil and fat based on the total amount of the plastic oil and fat composition. The content is preferably 70% by mass to 100% by mass, and more preferably 80% by mass to 100% by mass. A plastic oil and fat composition appropriate for bakery food dough can be obtained within the above ranges.

The content of a soybean hypocotyl oil in the edible oil and fat is 0.5% by mass to 20% by mass. The content of soybean hypocotyl oil is preferably 0.8% by mass or more, more preferably 1% by mass or more, still more preferably 2% by mass or more, even more preferably 3% by mass or more, and particularly preferably 4% by mass or more, and at the same time, it is preferably 15% by mass or less, more preferably 13% by mass or less, still more preferably 10% by mass or less, and even more preferably 8% by mass or less. A range in which these upper limit values and lower limit values are appropriately combined may be used. For example, the content of soybean hypocotyl oil in the edible oil and fat is preferably 0.8% by mass to 15% by mass, more preferably 1% by mass to 13% by mass, still more preferably 2% by mass to 13% by mass, even more preferably 3% by mass to 13% by mass, still even more preferably 3% by mass to 10% by mass, and particularly preferably 4% by mass to 8% by mass. Within the above range, a plastic oil and fat composition having excellent extensibility can be obtained.

The solid fat content of the edible oil and fat at 10° C. is preferably 20% to 70%, and more preferably 30% to 65%. In addition, the solid fat content at 35° C. is preferably 0% to 15%, and more preferably 2% to 12%. The solid fat content of the edible oil and fat can be measured in accordance with METHOD I described in AOCS Official Method Cd 16b-93.

The ratio of the soybean hypocotyl oil content (% by mass) in the edible oil and fat to the solid fat content (%) in the edible oil and fat at 10° C. is preferably 0.015 to 0.5, more preferably 0.02 to 0.4, still more preferably 0.03 to 0.3, and even more preferably 0.04 to 0.3. Within the above range, a plastic oil and fat composition having excellent extensibility can be obtained.

The edible oil and fat contains a raw material oil and fat other than soybean hypocotyl oil. Examples of such a raw material oil and fat include: vegetable fats and oils such as soybean oil, rapeseed oil, corn oil, cottonseed oil, rice oil, sunflower oil, safflower oil, sesame oil, olive oil, palm oil, palm kernel oil, and coconut oil; animal fats and oils such as fish oil, lard, beef tallow, and milk fat; medium chain fatty acid triglyceride; and processed fats and oils processed by one or more processing techniques selected from the group consisting of transesterification, hydrogenation, and fractionation.

The edible oil and fat contains preferably 0% by mass to 60% by mass, more preferably 0% by mass to 50% by mass, still more preferably 0% by mass to 40% by mass, and even more preferably 0% by mass to 30% by mass of liquid oil and fat (other than soybean hypocotyl oil) having a solid fat content of 0% to 5% at 10° C. The edible oil and fat preferably contains a liquid oil and fat (other than soybean hypocotyl oil) having a solid fat content of 0% to 5% at 10° C., and the lower limit in the above range is preferably more than 0% by mass. Examples of the liquid oil and fat include soybean oil, rapeseed oil, corn oil, cottonseed oil, rice oil, sunflower oil, safflower oil, sesame oil, olive oil, and medium chain fatty acid triglyceride. In a case in which the edible oil and fat contains a processed oil and fat, the processed oil and fat corresponds to the liquid oil and fat as long as the solid fat content in the processed oil and fat falls within the above range. In a case in which the edible oil and fat contains two or more types of the liquid fats and oils described above, the total amount of the liquid fats and oils is considered to be the content of the liquid oil and fat.

The ratio of the content of the liquid oil and fat to the content of the soybean hypocotyl oil in the edible oil and fat (liquid oil and fat/soybean hypocotyl oil) is preferably 0 to 100, more preferably 0 to 70, still more preferably 0 to 50, even more preferably 0 to 40, and particularly preferably 0 to 30 on a mass basis.

The plastic oil and fat composition of the present invention contains preferably 0% by mass to 40% by mass, more preferably 0% by mass to 30% by mass, and still more preferably 0% by mass to 20% by mass of water.

The plastic oil and fat composition of the present invention may optionally contain an emulsifier. The content of an emulsifier used is preferably more than 0% by mass to 5% by mass, more preferably more than 0% by mass to 3% by mass, and still more preferably more than 0% by mass to 2% by mass.

The plastic oil and fat composition of the present invention may contain other components unless the effects of the present invention are impaired. Examples of the components include, but are not limited to: antioxidants such as L-ascorbic acid, L-ascorbic acid derivatives, tocopherol, tocotrienol, lignan, ubiquinones, xanthines, oryzanol, catechins, polyphenols, and tea extract; colorants such as carotene; flavors; silicone; seasonings such as dietary salt, sugar, and amino acids; polysaccharides such as starch, xanthan gum, guar gum, gum arabic, pectin, locust bean gum, alginic acid, dextrin, and cellulose; milk components such as sodium caseinate and skim milk powder; emulsifiers such as lecithin, monoglycerin fatty acid ester, organic acid monofatty acid glyceride, polyglycerin fatty acid ester, polyglycerin condensed ricinoleic acid ester, propylene glycol fatty acid ester, sorbitan fatty acid ester, sucrose fatty acid ester, and polyoxyethylene sorbitan fatty acid ester.

In a case in which the plastic oil and fat composition of the present invention contains water, the total content of edible oil and fat and water is preferably 60% by mass to 100% by mass, more preferably 75% by mass to 100% by mass, still more preferably 90% by mass to 100% by mass, and even more preferably 95% by mass to 100% by mass.

The plastic oil and fat composition of the present invention is used for dough for a bakery food. The shape of the plastic oil and fat composition is not particularly limited, and it may be a block shape, a chip shape, a plate shape, or the like, and it is preferably a chip shape or a plate shape. The term “chip shape” used herein refers to a small piece with a long side of about 1 cm to 5 cm, and the term “block shape” used herein refers to a mass that is larger than such a small piece.

It is preferable that the plastic oil and fat composition is in a layered state in the dough. The layered state means a state in which the thinly shaped plastic oil and fat composition is present in a plurality of layers (two or more layers) in the dough. The number of layers of the plastic oil and fat composition in the dough may differ depending on the intended use and purpose, and therefore, it is not particularly limited. However, for example, a layered puffed food usually is allowed to have 27 layers or more.

For example, in a case in which the plastic oil and fat composition has a plate shape, the plastic oil and fat composition can be in the layered state by wrapping the plastic oil and fat composition with flour dough and repeating a step of extending and folding several times. In a case in which the plastic oil and fat composition has a chip shape, the plastic oil and fat composition can be in the layered state in the dough by mixing the plastic oil and fat composition in flour dough and dispersing the plastic oil and fat composition by lightly kneading the dough to such an extent that the plastic oil and fat composition is not kneaded into the flour dough. It is preferable to repeat the step of extending and folding the dough several times.

The content of the plastic oil and fat composition in the dough is preferably 15% by mass to 45% by mass. In a case in which the bakery food is a layered puffed food, the content of the plastic oil and fat composition in the dough is preferably 20% by mass to 45% by mass.

The dough contains flour such as wheat flour, rice flour, or soybean flour as well as the plastic oil and fat composition. In addition to the above, it may contain water, eggs, milk, dietary salt, sugar, yeast, starch, and the like.

A bakery food is obtained by heating the dough. Examples of the heating method include baking, deep-frying in oil, and steaming, preferably baking. Examples of the bakery food include: layered puffed foods such as croissants, Danish pastries, kneaded pies, and folded pies; breads such as sandwich bread and bread rolls; and baked sweets such as cookies, preferably a layered puffed food. It is preferable that the layered puffed food is obtained by heating bakery food dough into which the plastic oil and fat composition is mixed in such a way to form layers.

The method for producing a plastic oil and fat composition of the present invention includes: a step of preparing an oil and fat composition containing 60% by mass to 100% by mass of an edible oil and fat having a soybean hypocotyl oil content of 0.5% by mass to 20% by mass; and a step of quenching kneading the oil and fat composition.

The step in which the oil and fat composition is prepared may include a step of dissolving an oil-soluble component such as an emulsifier in the edible oil and fat, and it may include a step of adding an aqueous phase component to the edible oil and fat. In a case in which the step of adding an aqueous phase component is included, it preferably includes an emulsifying step. The aqueous phase component may contain seasonings and milk components as well as water.

The step of quenching kneading is a step of plasticizing the oil and fat composition to obtain a plastic oil and fat composition. An apparatus used in the step of quenching kneading is not particularly limited, and Perfector, Combinator, Votator, Nexus, or the like can be used.

According to preferred embodiments of the present invention, as the plastic oil and fat composition of the present invention has excellent extensibility, it is possible to form the plastic oil and fat composition in the layered state in dough for a bakery food with favorable workability during a work to form layers of the plastic oil and fat composition in flour dough. In addition, in a case in which the bakery food is a layered puffed food, it is possible to improve rising and crispy texture of the layered puffed food.

The present invention is also characterized by a method for improving extensibility of a plastic oil and fat composition containing an edible oil and fat, comprising allowing the edible oil and fat to contain soybean hypocotyl oil. It is preferable that the plastic oil and fat composition contains 60% by mass to 100% by mass of the edible oil and fat. It is also preferable that the edible oil and fat contains 0.5% by mass to 20% by mass of soybean hypocotyl oil. According to the present invention, extensibility of the plastic oil and fat composition containing the edible oil and fat can be improved, compared to a case in which the edible oil and fat does not contain soybean hypocotyl oil. The edible oil and fat and soybean hypocotyl oil, and the preferable ranges of their contents, the method for producing a plastic oil and fat composition, and the like are as described with respect to the plastic oil and fat composition of the present invention.

The present invention is also characterized by a method for improving rising of a layered puffed food, wherein the layered puffed food is obtained by heating dough for a bakery food in which a plastic oil and fat composition containing an edible oil and fat is mixed into flour dough in such a way to form layers, the method comprising allowing the edible oil and fat to contain soybean hypocotyl oil. The expression “rising of a layered puffed food” used herein means that a layered puffed food is in a puffed state in the height direction after heating compared to before heating. Such rising usually can be evaluated using the height of the layered puffed food as an index. However, in a case in which the difference from its comparison target becomes clearer, a value calculated as “the height of the layered puffed food/the length on the short side of the layered puffed food” may be used as an index. According to the present invention, rising of the layered puffed food can be improved, compared to a case in which the edible oil and fat does not contain soybean hypocotyl oil.

It is preferable that the plastic oil and fat composition contains 60% by mass to 100% by mass of the edible oil and fat in the method described above. It is also preferable that the edible oil and fat contains 0.5% by mass to 20% by mass of soybean hypocotyl oil. The edible oil and fat and soybean hypocotyl oil, and the preferable ranges of their contents, the method for producing a plastic oil and fat composition, and the like are as described with respect to the plastic oil and fat composition of the present invention. In addition, the dough for a bakery food, the heating method, and the like are also as described with respect to the plastic oil and fat composition of the present invention.

### Examples

Hereinafter, the present invention will be described in more detail with reference to Examples and Comparative Examples. However, the present invention is not limited to the following Examples.

### <Raw Materials>

The following were used for preparing a plastic oil and fat composition.

### (Raw Material Oil and Fat)

Soybean hypocotyl oil (solid fat content at 10° C.: 0%; prepared in Production Method I below)

Soybean oil (solid fat content at 10° C.: 0%; Purified soybean oil NS manufactured by J-OIL MILLS)

Palm oil (solid fat content at 10° C.: 50%; manufactured by J-OIL MILLS)

Palm olein (solid fat content at 10° C.: 35%; iodine value: 56; manufactured by J-OIL MILLS)

Transesterified oil 1 (solid fat content at 10° C.: 96%; prepared in Production Method 2 below)

Transesterified oil 2 (solid fat content at 10° C.: 69%; prepared in Production Method 3 below)

### (Emulsifier)

Monoglycerin fatty acid ester (Emalgy P-100 manufactured by RIKEN VITAMIN Co., Ltd.)

Lecithin (Lecithin FA manufactured by J-OIL MILLS)

(Production Method 1)

Soybean seeds were heated at 80° C. for 45 minutes and crushed to a size of less than ½ with a coarse grinder, thereby obtaining a mixture of seed leaf, seed coat, and hypocotyl. The obtained mixture was subjected to an air classifier to remove seed coat, thereby obtaining a mixture of seed leaf and hypocotyl. The resulting mixture of seed leaf and hypocotyl was subjected to sieving machine to remove a fraction which had not passed through a 7-mesh sieve, and furthermore a fraction between a 10-mesh sieve and a 14-mesh sieve was isolated to obtain a hypocotyl fraction (soybean hypocotyl: 40 wt %). The hypocotyl fraction was heated to 60° C. and flaked with a pressing machine, and then the oil was extracted with n-hexane, thereby obtaining miscella. Crude oil was obtained from the obtained miscella by removing residual n-hexane at 60° C. to 80° C. under reduced pressure. The crude oil was degummed, deoxidized, decolorized, and deodorized by a conventional method, thereby obtaining soybean hypocotyl oil.

(Production Method 2)

To a mixed oil in which 30 parts by mass of palm oil and 70 parts by mass of palm kernel oil (manufactured by J-OIL MILLS) were mixed, 0.3 parts by mass of sodium methoxide was added as a catalyst, and the mixture was stirred at 80° C. and a degree of vacuum of 2.7 kPa for 60 minutes, during which a random transesterification reaction was carried out. After the random transesterification, the catalyst was removed by washing with water, and hydrogenation was performed until an extremely hydrogenated oil was obtained. After hydrogenation, decolorization treatment was carried out using activated white earth, and further deodorization treatment was carried out, thereby obtaining transesterified oil 1.

(Production Method 3)

To a mixed oil in which 75 parts by mass of Palm stearin (iodine value: 32; manufactured by J-OIL MILLS), 10 parts by mass of palm oil, and 15 parts by mass of soybean oil were mixed, 0.3 parts by mass of sodium methoxide was added as a catalyst, and the mixture was stirred at 80° C. and a degree of vacuum of 2.7 kPa for 60 minutes, during which a random transesterification reaction was carried out. After the random transesterification, the catalyst was removed by washing with water, and further deodorization treatment was carried out, thereby obtaining transesterified oil 2.

<Method for Measuring Solid Fat Content>

The solid fat content of edible oil and fat was measured in accordance with METHOD I described in AOCS Official Method Cd 16b-93.

(Preparation of Plastic Oil and Fat Composition 1)

The edible fats and oils shown in Table 1 were separately placed in a mixing tank and stirred while heating at 65° C. Then, the amount of water at 65° C. shown in Table 2 was added to the mixing tank, and stirring was continued while maintaining the temperature at 65° C., thereby obtaining an emulsion. The obtained emulsion was passed through Perfector for quenching kneading, thereby obtaining a plastic oil and fat composition. Here, each plastic oil and fat composition was molded into a columnar shape (chip shape) such that it could have a diameter of 6 mm and a length of 3 cm at the time of filling.

TABLE 1

| | | Edible oil and | Edible oil and |
|---|---|---|---|
| Raw material oil and fat | | fat 1 | fat 2 |
| Soybean hypocotyl oil | | 2.5% by mass | |
| Soybean oil | | 2.5% by mass | 5% by mass |
| Palm oil | | 40% by mass | 40% by mass |
| Palm olein | | 15% by mass | 15% by mass |
| Transesterified oil 1 | | 10% by mass | 10% by mass |
| Transesterified oil 2 | | 30% by mass | 30% by mass |
| Total | | 100% by mass | 100% by mass |
| Solid fat content | 10° C. | 57 | 56 |
| of edible oil and | 35° C. | 9 | 8 |
| fat (%) | | | |

TABLE 2

| | | Comparative |
|---|---|---|
| Ingredients | Example 1 | Example 1 |
| Edible oil and fat 1 | 84% by mass | |
| Edible oil and fat 2 | | 84% by mass |
| Water | 16% by mass | 16% by mass |
| Total | 100% by mass | 100% by mass |
| State of Kneading | The plastic oil and | Since plastic oil |
| After Adding | fat composition is | and fat composition |
| Plastic Oil and Fat | easy to break into | particles tend to |
| Composition | particles and thus | stick to each other, |
| | is easily dispersed | it took a long time |
| | in the flour dough. | to disperse them |
| | | in the flour dough. |
| Mixing Time after | 60 seconds | 70 seconds |
| Introducing Plastic | | |
| Oil and Fat | | |
| Composition | | |
| State When | The plastic oil and | The plastic oil and |
| Extended with | fat composition is | fat composition is |
| Reverse Seater | extended together | harder to extend |
| | with the flour | than the flour |
| | dough. | dough. |
| Rising of kneaded | 0.67 | 0.47 |
| pie* | | |
| State and Texture | Favorable rising, | Unfavorable rising, |
| of Kneaded Pie | uniformly formed | roughly formed |
| | layers, and a crispy | layers, and a |
| | texture are con- | crunchy texture |
| | firmed. | are confirmed. |

*Rising of kneaded pie was determined to be the average value of 6 samples calculated by “height of kneaded pie/short side length side of kneaded pie.”

(Preparation of Kneaded Pie)

Ingredients other than the plastic oil and fat composition shown in Table 3 were placed in a bowl of a vertical mixer (KANTO KONGOKI INDUSTRIAL CO., LTD.). The bowl was attached to the vertical mixer with a hook and mixed at the first speed for 4 minutes, thereby preparing flour dough. The mixing was temporarily stopped to introduce the amount of the plastic oil and fat composition shown in Table 3 into the bowl, and mixing was resumed at the first speed for the corresponding period of time shown in Table 2, thereby preparing pie dough in which the plastic oil and fat composition was dispersed. The mixed pie dough was transferred from the bowl to a reverse seater, extended to a thickness of 4 mm, folded in four, extended again to a thickness of 4 mm, and further folded in four. The pie dough folded in four twice was allowed to rest at 5° C. for 90 minutes, extended to a thickness of 4 mm using the reverse sheeter, and then cut into a rectangle having a long side of 12 cm and a short side of 5 cm. The cut pie dough was baked in an oven set at 210° C. in the upper rack and 210° C. in the lower rack for 20 minutes, thereby preparing a kneaded pie.

TABLE 3

| | Compounding |
|---|---|
| Ingredients | amount (g) |
| Hard flour (20° C.) | 450 |
| Soft flour (20° C.) | 1050 |
| Dietary salt (20° C.) | 18 |
| Whole egg (20° C.) | 180 |
| Water (5° C.) | 720 |
| Plastic oil and fat | 750 |
| composition (5° C.) | |

*The parentheses of the ingredients indicate the temperature at the time of introduction into the bowl.

Evaluation of the preparation of the kneaded pie and the evaluation of the kneaded pie were carried out for the items shown in Table 2, and the results are shown in Table 2.

The plastic oil and fat composition of the Example was easily mixed in the flour dough and could be dispersed by mixing for a short period of time. When extended with the reverse sheeter, the plastic oil and fat composition had favorable extensibility and was extended together with the flour dough. Accordingly, the plastic oil and fat composition was allowed to be distributed in the flour dough, allowing the baked kneaded pie to have uniformly formed layers with favorable rising. Particles of the plastic oil and fat composition of the Comparative Example tended to stick to each other, and therefore, it took a long time to mix the plastic oil and fat composition with the flour dough, causing the flour dough to be partially integrated with the plastic oil and fat composition. In this case, when extended with the reverse sheeter, the plastic oil and fat composition was less likely to be extended than the flour dough. Accordingly, the plastic oil and fat composition was unlikely to be distributed in the flour dough. As a result, the obtained kneaded pie showed poor rising and did not have uniformly formed layers.

(Preparation of Plastic Oil and Fat Composition 2)

Table 4 shows the formulations of edible fats and oils to be used in a plastic oil and fat composition.

The ingredients of oil phase shown in Table 5 were separately placed in a mixing tank and stirred while heating at 65° C. Then, the amounts of ingredients of aqueous phase shown in Table 5 were mixed for dissolution in advance, and then added to the mixing tank, and stirring was continued while maintaining the temperature at 65° C., thereby obtaining an emulsion. The obtained emulsion was passed through Perfector for quenching kneading, thereby obtaining a plastic oil and fat composition. Each plastic oil and fat composition was molded into a 500 g plate having a thickness of 10 mm, a width of 21 cm, and a length of 24 cm at the time of filling.

TABLE 4
Unit is “% by mass” except for those described.

| | | Edible | Edible | Edible | Edible | Edible | Edible |
|---|---|---|---|---|---|---|---|
| Raw material | | oil and | oil and | oil and | oil and | oil and | oil and |
| oil and fat | | fat 4-1 | fat 4-2 | fat 4-3 | fat 4-4 | fat 4-5 | fat 4-6 |
| Soybean | | | 0.25 | 1 | 2.5 | 5 | 12.5 |
| hypocotyl oil | | | | | | | |
| Soybean oil | | 25 | 24.75 | 24 | 22.5 | 20 | 12.5 |
| Palm oil | | 29 | 29 | 29 | 29 | 29 | 29 |
| Transesterified | | 10 | 10 | 10 | 10 | 10 | 10 |
| oil 1 | | | | | | | |
| Transesterified | | 36 | 36 | 36 | 36 | 36 | 36 |
| oil 2 | | | | | | | |
| Total | | 100 | 100 | 100 | 100 | 100 | 100 |
| Solid fat | 10° | 48 | 48 | 48 | 48 | 48 | 48 |
| content of | C. | | | | | | |
| edible | 35° | 9 | 9 | 9 | 9 | 9 | 9 |
| oil and | C. | | | | | | |
| fat (%) | | | | | | | |

TABLE 5
Unit is “% by mass.”

| | | Comparative | Comparative | Example | Example | Example | Example |
|---|---|---|---|---|---|---|---|
| Ingredients | | Example 5-1 | Example 5-2 | 5-1 | 5-2 | 5-3 | 5-4 |
| Oil phase | Edible oil | 82.44 | | | | | |
| | and fat 4-1 | | | | | | |
| | Edible oil | | 82.44 | | | | |
| | and fat4-2 | | | | | | |
| | Edible oil | | | 82.44 | | | |
| | and fat 4-3 | | | | | | |
| | Edible oil | | | | 82.44 | | |
| | and fat 4-4 | | | | | | |
| | Edible oil | | | | | 82.44 | |
| | and fat 4-5 | | | | | | |
| | Edible oil | | | | | | 82.44 |
| | and fat 4-6 | | | | | | |
| | Monoglycerin | 0.4 | 0.4 | 0.4 | 0.4 | 0.4 | 0.4 |
| | fatty acid ester | | | | | | |
| | Lecithin | 0.16 | 0.16 | 0.16 | 0.16 | 0.16 | 0.16 |
| Aqueous | Water | 16 | 16 | 16 | 16 | 16 | 16 |
| phase | Dietary salt | 1 | 1 | 1 | 1 | 1 | 1 |

| | | | | | | |
|---|---|---|---|---|---|---|
| Total | 100 | 100 | 100 | 100 | 100 | 100 |

### (Preparation of Danish Pastry)

The following were used for preparation of Danish pastries.

Bread making improver: PRIMA PANE (manufactured by Puratos)

Raw yeast: Regular raw yeast (manufactured by ORIENTAL YEAST CO., LTD.)

Oil and fat to be kneaded: Facier (manufactured by J-OIL MILLS)

Ingredients other than the plastic oil and fat composition shown in Table 6 were placed in a bowl of a vertical mixer (KANTO KONGOKI INDUSTRIAL CO., LTD.). The bowl was attached to the vertical mixer with a hook and mixed at the first speed for 6 minutes and the second speed for 6 minutes, thereby preparing flour dough. The prepared flour dough was taken out of the bowl, allowed to rest at 23° C. for 20 minutes, formed to have a thickness of 10 mm, and stored in a freezer set at −5° C. for 16 hours. The flour dough was taken out of the freezer to wrap each plastic oil and fat composition adjusted to 15° C., thereby preparing Danish pastry dough. The Danish pastry dough was extended to a thickness of 8 mm using the reverse seater, folded in three, extended again to a thickness of 8 mm, further folded in three, and extended to a thickness of 7 mm using the reverse seater. The Danish pastry dough folded in three twice was stored in a freezer set at −5° C. for 60 minutes. The Danish pastry dough taken out of the freezer was folded in three, extended to a thickness of 7 mm using the reverse sheeter, and stored again in the freezer set at −5° C. for 60 minutes. The Danish pastry dough taken out of the freezer was extended to a thickness of 3 mm using the reverse sheeter, and then cut into a square having a side of 11 cm. The cut Danish pastry dough was fermented at 36° C. and a relative humidity of 75% for 60 minutes. The fermented Danish pastry dough was baked in an oven set at 200° C. in the upper rack and 190° C. in the lower rack for 14 minutes, thereby obtaining Danish pastries.

TABLE 6

| | Compounding |
|---|---|
| Ingredients | amount (g) |
| Hard flour (20° C.) | 940 |
| Bread making | 4.7 |
| improver (20° C.) | |
| Raw yeast (5° C.) | 47 |
| Superfine sugar | 75.2 |
| (20° C.) | |
| Dietary salt (20° C.) | 15.98 |
| Skim milk powder | 28.2 |
| (20° C.) | |
| Oil and fat to be | 75.2 |
| kneaded (15° C.) | |
| Whole egg (5° C.) | 56.4 |
| Water (2° C.) | 423 |
| Plastic oil and fat | 500 |
| composition | |

*The parentheses of the ingredients indicate the temperature at the time of introduction into the bowl.

Evaluation of the preparation of Danish pastries and the evaluation of the obtained Danish pastries were carried out for the items shown in Table 7, and the results are shown in Table 7. Here, the item of rising of Danish pastry was evaluated by calculating the average height of the 6 selected samples.

TABLE 7

| Plastic oil | | | | | | |
|---|---|---|---|---|---|---|
| and fat | Comparative | Comparative | | | | |
| composition | Example | Example | Example | Example | Example | Example |
| used | 5-1 | 5-2 | 5-1 | 5-2 | 5-3 | 5-4 |
| State of | Plastic oil and | Plastic oil and | Plastic oil | Plastic oil | Plastic oil | Plastic oil |
| Danish | fat | fat | and fat | and fat | and fat | and fat |
| Pastry | composition | composition | composition | composition | composition | composition |
| Dough | could not be | could not be | could be | could be | could be | could be |
| When | extended to | extended to | extended to | extended to | extended to | extended to |
| Extended | the same | the same | almost the | the same | the same | the same |
| with | extent as flour | extent as flour | same extent | extent as | extent as | extent as |
| Reverse | dough | dough | as flour | flour dough | flour dough | flour dough |
| Seater | | | dough | | | |
| Rising of | 1 | 1.00 | 1.10 | 1.13 | 1.20 | 1.16 |
| Danish | | | | | | |
| Pastry* | | | | | | |
| State of | Layers are not | Layers are not | Layers are | Layers are | Layers are | Layers are |
| Inner layers | uniformly | uniformly | uniformly | uniformly | uniformly | uniformly |
| of Danish | formed. | formed. | formed. | formed. | formed. | formed. |
| Pastry | | | | | | |
| Texture of | Poor | Poor | Crispy | Crispy | Crispy | Crispy |
| Danish | chewiness | chewiness | texture can | texture can | texture can | texture can |
| Pastry | with lack of | with lack of | be felt. | be felt. | be felt. | be felt. |
| | crispy texture | crispy texture | | | | |

*The relative value when the height of Danish pastry using Comparative Example 5-1 is 1.

The plastic oil and fat compositions in the Examples showed favorable extensibility, and could be extended to the same extent as the flour dough when the Danish pastry dough was extended with the reverse seater. In particular, the plastic oil and fat composition containing 2.5% by mass to 12.5% by mass of soybean hypocotyl oil in edible oil and fat showed excellent extensibility and had excellent extensibility to the same extent as the flour dough. Meanwhile, the plastic oil and fat composition containing no soybean hypocotyl oil or 0.25% by mass of soybean hypocotyl oil in edible oil and fat could not be extended to the same extent as the flour dough. Accordingly, the Danish pastry dough mostly contained flour dough.

Danish pastries for which the plastic oil and fat compositions of the Examples were used showed favorable rising compared to the Danish pastries for which the plastic oil and fat composition of Comparative Example 5-1 was used. Their inner layers were uniformly formed in a layered structure, and their texture was crispy, which were favorable. In particular, the Danish pastries for which the plastic oil and fat composition containing 2.5% by mass to 12.5% by mass of soybean hypocotyl oil in edible oil and fat was used showed favorable rising and was excellent in terms of both shape and texture. Meanwhile, the Danish pastries for which the plastic oil and fat composition containing no soybean hypocotyl oil or 0.25% by mass of soybean hypocotyl oil in edible oil and fat was used was not confirmed to have uniformly formed inner layers, and the chewiness was poor with lack of crispy texture specific to Danish pastries.

1. A plastic oil and fat composition for dough for a bakery food, comprising 60% by mass to 100% by mass of an edible oil and fat, wherein the edible oil and fat contains 0.5% by mass to 20% by mass of soybean hypocotyl oil.

2. The plastic oil and fat composition according to claim 1, wherein the edible oil and fat has a solid fat content of 20% to 70% at 10° C. and a solid fat content of 0% to 15% at 35° C.

3. The plastic oil and fat composition according to claim 1, wherein the edible oil and fat contains 0% by mass to 60% by mass of a liquid oil and fat (other than soybean hypocotyl oil) having a solid fat content of 0% to 5% at 10° C.

4. The plastic oil and fat composition according to claim 3, wherein the ratio of the content of the liquid oil and fat to the content of the soybean hypocotyl oil (liquid oil and fat/soybean hypocotyl oil) in the edible oil and fat is 0 to 100 on a mass basis.

5. The plastic oil and fat composition according to claim 1, wherein the bakery food is a layered puffed food.

6. Dough for a bakery food, comprising the plastic oil and fat composition according to claim 1.

7. The dough according to claim 6, wherein the plastic oil and fat composition is mixed thereinto in such a way to form layers.

8. A bakery food, which is obtained by heating the dough according to claim 6.

9. A method for producing a plastic oil and fat composition for dough for a bakery food, comprising:
a step of preparing an oil and fat composition containing 60% by mass to 100% by mass of an edible oil and fat having a soybean hypocotyl oil content of 0.5% by mass to 20% by mass; and
a step of quenching kneading the oil and fat composition.

10. A method for improving extensibility of a plastic oil and fat composition containing an edible oil and fat, comprising allowing the edible oil and fat to contain a soybean hypocotyl oil.

11. A method for improving rising of a layered puffed food, wherein the layered puffed food is obtained by heating dough for a bakery food in which a plastic oil and fat composition containing an edible oil and fat is mixed into flour dough in such a way to form layers, the method comprising allowing the edible oil and fat to contain soybean hypocotyl oil
